(19) United States
(12) Patent Application Publication
(10) Pub. No.: US 2011/0001723 A1
(43) Pub. Date: Jan. 6, 2011

(54) TOUCH PANEL AND SENSING METHOD THEREOF

(76) Inventor: Hsiang-Pin Fan, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/605,367

(22) Filed: Oct. 25, 2009

(30) Foreign Application Priority Data
Jul. 1, 2009 (TW) 098122248

(51) Int. Cl. G06F 3/041; G06F 3/045; G09G 3/36

(52) U.S. Cl. 345/174; 345/173; 345/87

(57) ABSTRACT

The first substrate of the touch panel includes a pixel array and a plurality of sensing lines. The pixel array includes a plurality of scan lines, a plurality of data lines and a plurality of pixel electrodes. The sensing lines are parallel arranged in the pixel array, adjacent to parts of the pixel electrodes, and electrically insulated from the scan lines, the data lines and the pixel electrodes. The second substrate of the touch panel includes a plurality of conductive protrusions disposed corresponding to the sensing lines. When there is no external force applied to the touch panel, the conductive protrusions are electrically insulated from the scan lines and the pixel array. When an external force is applied to the touch panel, at least one of the conductive protrusions may contact both one of the scan lines and parts of the pixel array.

### BACKGROUND OF THE INVENTION

1. Field of the Invention

The present invention relates to a touch panel and a sensing method, and more particularly, to a touch function incorporated display panel and its sensing method.

2. Description of the Prior Art

In the present consumer electronic market, touch panels, which serve as interfaces between users and the electronic devices, have been widely applied in portable electronic devices such as personal digital assistants (PDA), mobile phones, and notebooks. Since modern electronic products increasingly become smaller, lighter, thinner, and shorter, a display device with a touch panel has gradually become a key component of various electronic products in order to save space and to replace traditional input apparatuses, such as operation buttons, keyboards, and mouse, under the demands of humanized designed tablet personal computer (PC).

Industries have tried to incorporate a touch sensing function into liquid crystal displays through a press-type liquid crystal display panel where deformations of a top substrate generate sensing signals. Please refer to FIG. 1. FIG. 1 is a schematic diagram of a prior art press-type touch panel. The prior art press-type touch panel 10 includes a plurality of display regions 16, and a plurality of sensing regions 12. Each display region 16 includes a data line 18, a scan line 22, a thin film transistor TFTₚᵢₓₑₗ, a storage capacitor Cst, and a liquid crystal capacitor C_{LC1}, wherein within the thin film transistor TFTₚᵢₓₑₗ, a gate electrode is electrically connected to the scan line 22, and a source electrode is electrically connected to the data line 18, and a drain electrode is electrically connected to a pixel electrode. The primary function of the display region 16 is to displays images via delivering data signals from the thin film transistor TFTₚᵢₓₑₗ to the pixel electrodes though the data lines 18, which interact with a common voltage V_{com} of a common electrode, located at one side of the top substrate to create an electric field able to rotate liquid crystals.

The sensing region 12 includes a sensing line 20, a sensing structure C_{LC2}, and a thin film transistor TFT_{Readout}. The sensing structure C_{LC2} further includes parts of a common electrode at a side of the top substrate. The conventional press-type touch panel 10 includes a complete common electrode with the common voltage V_{com}, in which the top substrate is completely covered by a transparent conductive layer. Pressing the press-type touch panel 10 concaves the top substrate, and the common electrode on the top substrate contacts the source electrode of the thin film transistor TFT_{Readout} of a bottom substrate; therefore, the common voltage V_{com} of the common electrode passes through the thin film transistor TFT_{Readout} and the sensing line 20 and reaches to an amplifier, which then becomes a touch signal.

However, the thin film transistor TFT_{Readout} and the connected sensing structure C_{LC2} occupy a massive amount of layout area, decreasing available pixel areas for image display as well as decreasing aperture ratios. Therefore, manufacturers of touch panels and display devices must continue in research in order to manufacture an all-around product that is thinner in size, lower in cost, and better in efficiency.

### SUMMARY OF THE INVENTION

One of the objectives of the present invention is to provide a flat display panel with touch functions as well as a new sensing structure, which improves the issue of losing the aperture ratio of the conventional touch panels.

To achieve the above objective, an embodiment of the present invention of a touch panel includes a first substrate, a second substrate, and a liquid crystal layer. The first substrate includes a pixel array and a plurality of sensing lines. The pixel array includes a plurality of scan lines extending in a row direction, a plurality of data lines extending in a column direction, and a plurality of pixel electrodes. The pixel electrodes are disposed between the scan lines and the data lines, and connected to corresponding scan lines and data lines. The sensing lines are disposed in parallel in the pixel array near parts of the pixel electrodes and electrically insulated from the scan lines, the data lines, and the pixel electrodes. The second substrate includes a plurality of conductive protrusions disposed corresponding to the sensing lines. The liquid crystal layer is disposed between the first substrate and the second substrate. When an external force is applied to the touch panel, at least one of the conductive protrusions contacts both one of the sensing line and parts of the pixel array, and a sensing signal is transferred by one of the sensing line.

The embodiments of the present invention further provide a sensing method of the previous described touch panel. The sensing method includes, providing scan signals to the scan lines; applying an external force to the touch panel such that the conductive protrusions contact both one of the sensing lines and parts of the pixel array; transferring the sensing signal by one of the sensing lines; and determining corresponding locations of the sensing signals.

Therefore, the present invention utilizes the conductive protrusion of the top substrate as a bridge structure; when pressed, the conductive protrusion of the top substrate contacts the sensing line and the pixel array below which transfers the signals of the pixel to the sensing lines. Therefore, the sensor readout transistors are not required at the pixel array which effectively increased the aperture ratio of the pixel array. Also, the common electrode on the top substrate of the present invention does not cover the surface of the spacer photoresist completely, which shortens a distance between the pixel electrode and the main photospacer and further increases the aperture ratio.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional press-type touch panel.

FIG. 2(a) is a schematic diagram of a cross-sectional view of the sensing structure of the touch panel of the first embodiment of the present invention.

FIG. 2(b) is a schematic diagram of a cross-sectional view of the main photospacer of the touch panel of the first embodiment of the present invention.

FIG. 3 is a schematic perspective layout diagram of the touch panel of the first embodiment of the present invention.

FIG. 4 is a schematic diagram of the touch panel of the first embodiment of the present invention when pressed.

FIG. 5 is a schematic diagram of the conductive protrusion of the first embodiment of the present invention.

FIG. 6 is a schematic diagram of the conductive protrusion of a modified embodiment of the present invention.

FIG. 7 is a schematic diagram of the equivalent circuit of the touch panel of the first embodiment of the present invention.

FIG. 8 is a schematic diagram of the equivalent circuit of a touch panel of the second embodiment of the present invention.

FIG. 9 is a schematic diagram of the driving sequence with corresponding sensing signals of the touch panel of the second embodiment of the present invention.

FIG. 10 is a schematic perspective layout diagram of the touch panel.

FIG. 11 is a schematic diagram of the equivalent circuit of the touch panel.

FIG. 12 is a schematic diagram of the driving sequence with corresponding sensing signals of the touch panel.

FIG. 13 is a perspective layout diagram of the touch panel.

FIG. 14 is an equivalent circuit diagram of the touch panel.

FIG. 15 is a schematic diagram of the driving sequence of the corresponding sensing signals of touch panel.

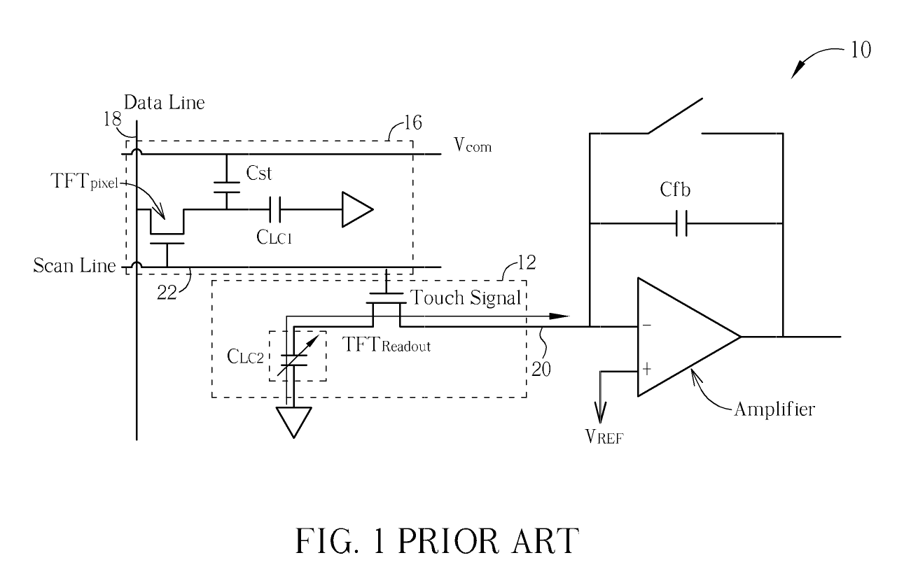

### DETAILED DESCRIPTION

Hereinafter, preferred embodiments of the touch panel and the sensing method of the present invention will be described in detail with reference to the accompanying drawings. Here, it is to be noted that the present invention is not limited thereto. Furthermore, the step serial numbers concerning the touch panel and the sensing method are not meant thereto limit the operating sequence, and any rearrangement of the operating sequence for achieving same functionality is still within the spirit and scope of the invention. It is to be understood that the drawings are not drawn to scale and are only for illustration purposes.

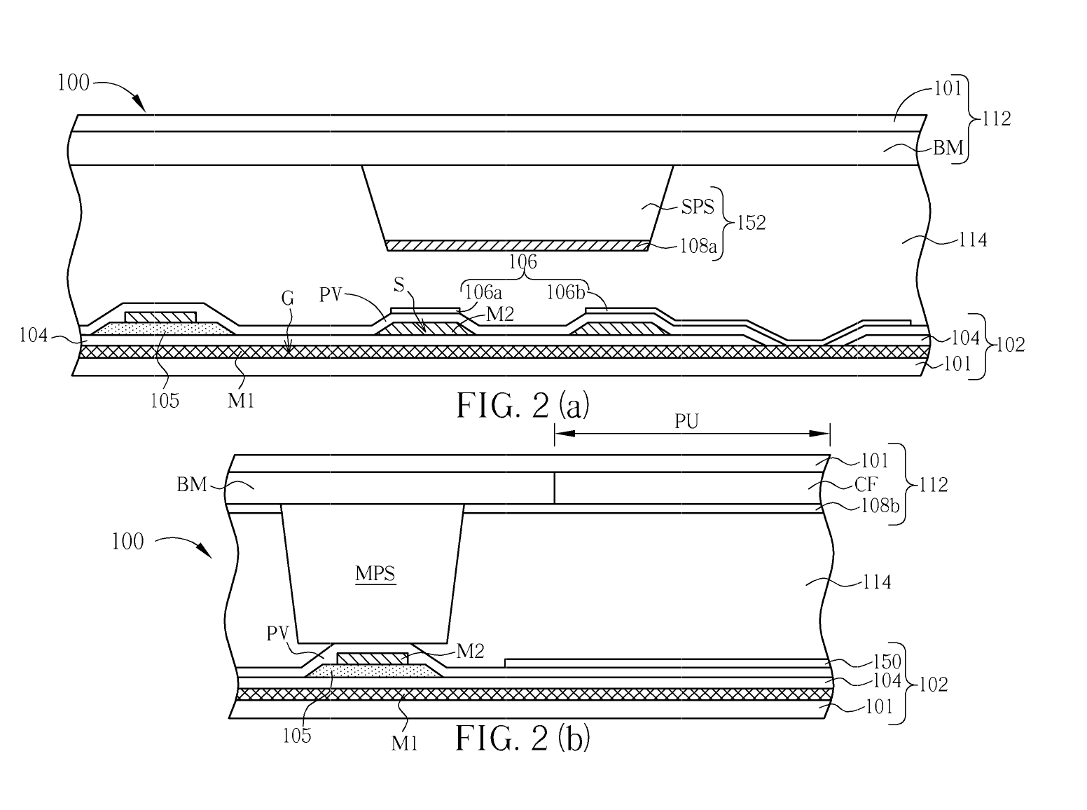

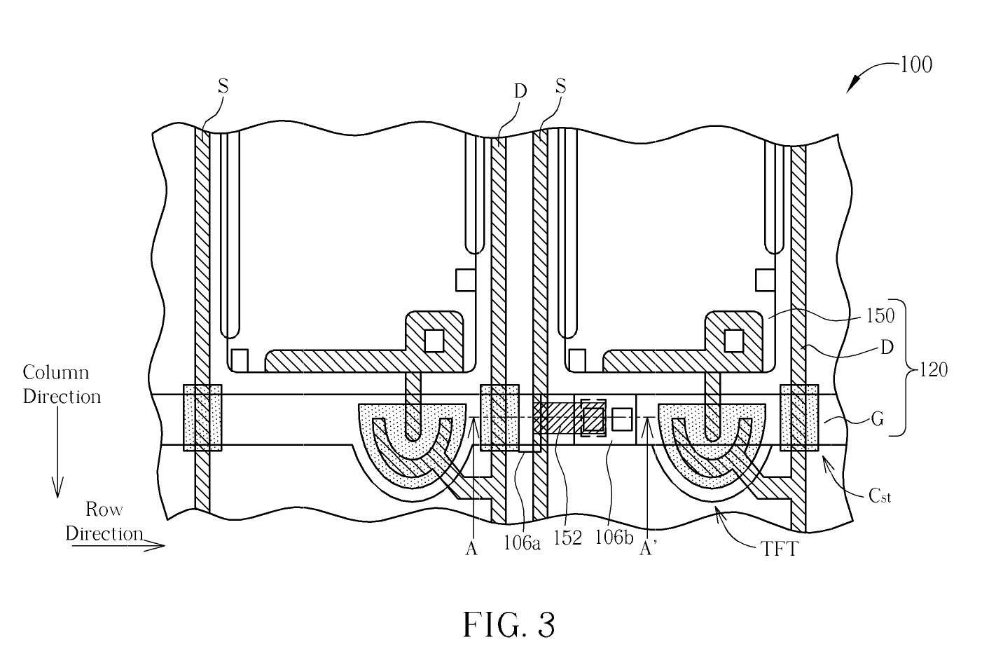

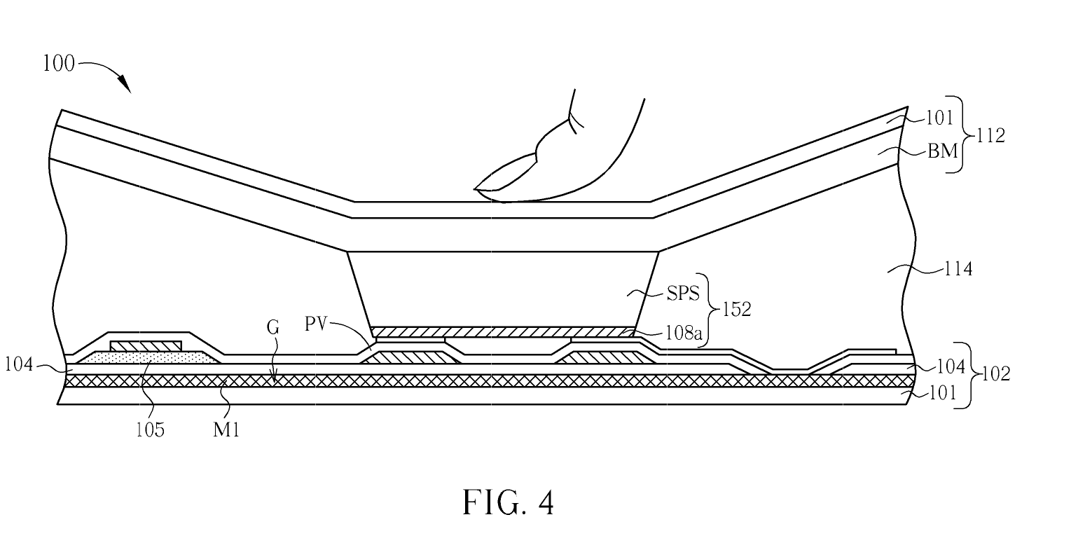

FIG. 2 to FIG. 4 are schematic diagrams of an in-cell touch panel 100 of a first embodiment of the present invention, wherein FIG. 2(a) is a schematic diagram of a cross-sectional view of the sensing structure of the touch panel 100 along the A-A′ line of FIG. 3; FIG. 2(b) is a schematic diagram of a cross-sectional view of the main photospacer of the touch panel 100; FIG. 3 is a schematic perspective layout diagram of the touch panel 100; FIG. 4 is a schematic diagram of the touch panel when pressed. The touch panel 100 of the present invention is a panel with a touch function and a display function. As illustrated in FIG. 2, the touch panel 100 includes a first substrate 102, a second substrate 112, and a liquid crystal layer 114 disposed between the first substrate 102 and the second substrate 112. Base plates 101 for the first substrate 102 and the second substrate 112 are made of transparent materials such as glass or quartz, and fixed by a sealant in-between.

The first substrate 102 includes the base plate 101, a first metallic layer M1 covering the base plate 101, a dielectric layer 104 covering the first metallic layer M1, a semiconductor layer 105 formed on the dielectric layer 104, a second metallic layer M2 formed on the dielectric layer 104 and the semiconductor layer 105, a passivation layer PV covering the dielectric layer 104, the semiconductor layer 105 and the second metallic layer M2, and a patterned conductive layer 106 covering parts of the passivation layer PV. The patterned conductive layer 106 includes a connection terminal 106a and another connection terminal 106b of FIG. 2(a), and a pixel electrode 150 of FIG. 2(b). Also, the patterned conductive layer 106 preferably includes transparent conductive materials such as Indium Tin Oxide (ITO) or Indium Zinc Oxide (IZO) for light to pass through.

As illustrated in FIG. 2(a), the second substrate 112 includes a plurality of conductive protrusions 152 disposed corresponding to the sensing lines S respectively. The conductive protrusion 152 includes a protrusion member SPS and a conductive layer 108a, wherein the protrusion member SPS includes at least a photoresist layer, or at least an organic layer, or at least a black matrix. In the present embodiment, the protrusion member SPS is a spacer photoresist layer, for instance. The conductive layer 108a is disposed on parts of the surfaces of the previous discussed spacer photoresist layer, or the organic layer or the black matrix. For example, the conductive layer 108a only covers all of the bottom surface of the protrusion member SPS (at the side facing the first substrate 102), or covers parts of the bottom surface of the protrusion member SPS, or covers all of the bottom surface and all sides of the protrusion member SPS, or covers parts of the bottom surface and parts of the sides of the protrusion member SPS.

When no external force is applied, the conductive protrusion 152 is disposed above the connection terminals 106a and 106b without contact. Namely, under no external applied force, the sensing line S and the scan line G are electrically insulated. According to this, corresponding conductive protrusion 152 and connection terminations 106a and 106b construct a sensing structure. The connection terminals 106a and 106b of the present embodiment are electrically connected to one of the sensing lines S and one of the scan lines G respectively. For instance, the connection terminal 106b contacts the scan line G through penetrating the opening of the passivation layer PV and the opening of dielectric layer 104, and the connection terminal 106a contacts the sensing line S through penetrating the opening of the passivation layer PV (not illustrated in FIG. 2(a)).

As illustrated in FIG. 2(b), the second substrate 112 further includes a black matrix BM, a plurality of pixel units PU, and a main photospacer MPS. The black matrix BM defines the locations of the pixel units PU, aligning the pixel units PU to corresponding pixel electrodes 150. The main photospacer MPS assists in supporting of the first substrate 102 and the second substrate 112. The pixel unit PU includes color filters CF and a common electrode 108b, wherein the common electrode 108b covers an entire surface of the second substrate 112 within the pixel unit PU, but is electrically insulated from the conductive layer 108a of the conductive protrusion 152. In other words, it is not required for the common electrode 108b to cover the protrusion member SPS and the main photospacer MPS of the second substrate 112, such that the conductive protrusion 152 and the pixel units PU are electrically insulated. Since it is not required for the common electrode 108b of the second substrate 112 to cover the entire surfaces of the protrusion member SPS and the main photospacer MPS, short circuiting between the pixel electrodes 150 and the common electrodes 108b is unlikely to occur. Therefore, in order to increase the aperture ratio, a distance between the pixel electrode 150 and the main photospacer MPS may be shortened during the pixel design layout and actual manufacturing.

Please refer to FIG. 2 and FIG. 3. The first metallic layer M1 of FIG. 2 may be the scan line G of FIG. 3; the semiconductor layer 105 of FIG. 2 may be a channel region for a thin film transistor TFT and a top electrode of the storage capacitor Cst of FIG. 3. The second metallic layer M2 of FIG. 2 may be the sensing line S, the data line D and a metallic material of a source electrode and a drain electrode of the thin film transistor TFT of FIG. 3; the patterned conductive layer 106 of FIG. 2 includes the connection terminal 106a, the connection terminal 106b, and the pixel electrode 150 of FIG. 3. Accordingly, the first substrate 102 of FIG. 2 includes a pixel array 120 and a plurality of sensing line S of FIG. 3.

As illustrated in FIG. 3, the pixel array 120 includes a plurality of scan lines G extending in a row direction (to better describe the layout, FIG. 3 only illustrates one scan line G), a plurality of data lines D extending in a column direction, and a plurality of pixel electrodes 150. The pixel electrodes 150 are disposed between the scan lines G and the data lines D, and connected to corresponding scan lines G and data lines D. The sensing lines S are aligned in parallel in the pixel array 120, disposed near parts of the pixel electrodes 150, and electrically insulated from the scan lines G, the data lines D, and the pixel electrodes 150. For instance, the sensing lines S of the present embodiment may extend along the column direction.

As illustrated in FIG. 4, when an external force is applied to the touch panel 100, the external force pushes the conductive protrusion 152 downwards so the conductive protrusion 152 contacts both one of the sensing lines S and one of the scan lines G, such that the conductive protrusion 152 contacts both one of the sensing lines S and parts of the pixel array. Therefore, the conductive layer 108a of the conductive protrusion 152 is electrically connected to both one of the sensing lines S and one of the scan lines G, and the conductive layer 108a transfers the sensing signals through the connected sensing lines S.

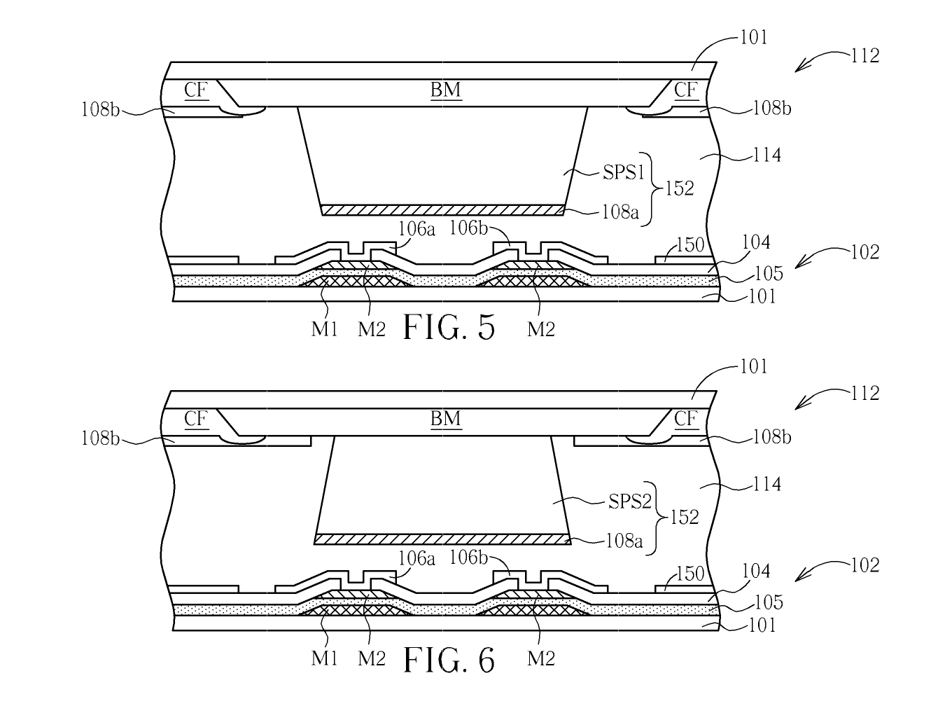

In order to electrically insulate the conductive protrusions 152 from the pixel units PU, the present invention manufactures the conductive protrusions 152 using methods illustrated in FIG. 5 or FIG. 6. As illustrated in FIG. 5, after a protrusion member SPS1 is formed at an inner surface of the second substrate 112, a conductive layer (such as ITO, IZO, or other transparent conductive materials) is deposited at the inner surface of the second substrate 112. A patterning process is applied to the conductive layer through the following steps: first a photoresist layer is coated on the conductive layer; a photolithography process is then performed on the photoresist layer; a patterned photoresist layer acts as an etching mask to etch the conductive layer, forming the conductive layer 108a and the common electrode 108b electrically insulated from each other; and finally the photoresist layer on the conductive layer 108a and the common electrode 108b is removed. The protrusion member SPS1 of the present embodiment may be any appropriate shapes. For instance, a cross-section of the protrusion member SPS1 gradually shrinks from a surface of the black matrix BM towards the first substrate 102 (from top to bottom). The advantage of this manufacturing process is that only an additional conductive layer patterning process is added to a standard manufacturing process of a display panel to form the conductive layer 108a and the common electrode 108b. Also, the patterns of the conductive layer 108a and patterns of the common electrode 108b may be adjusted easily based on different design layouts to meet various needs.

Alternatively, as illustrated in FIG. 6, the present embodiment first forms a protrusion member SPS2 with a bottom width greater than a top width on an inner surface of the second substrate 112, then a conductive layer is deposited over the entire inner surface of the second substrate 112. Due to the gradually expanding cross-section of the protrusion member SPS2 from a surface of the black matrix BM towards the first substrate 102 (from top to bottom), an included angle between a side of the protrusion member SPS2 and the black matrix BM is less than 90 degree; therefore, the protrusion member SPS2 exhibits the effect of masking and segmenting, allowing a later deposited conductive layer to self separate into a conductive layer 108a and a common electrode 108b electrically insulated from each other. One advantage of such manufacturing process is by only changing the shape of the protrusion member SPS2, the conductive layer 108a and the common electrode 108b separate simultaneously without further patterning steps which simplifies the manufacturing process.

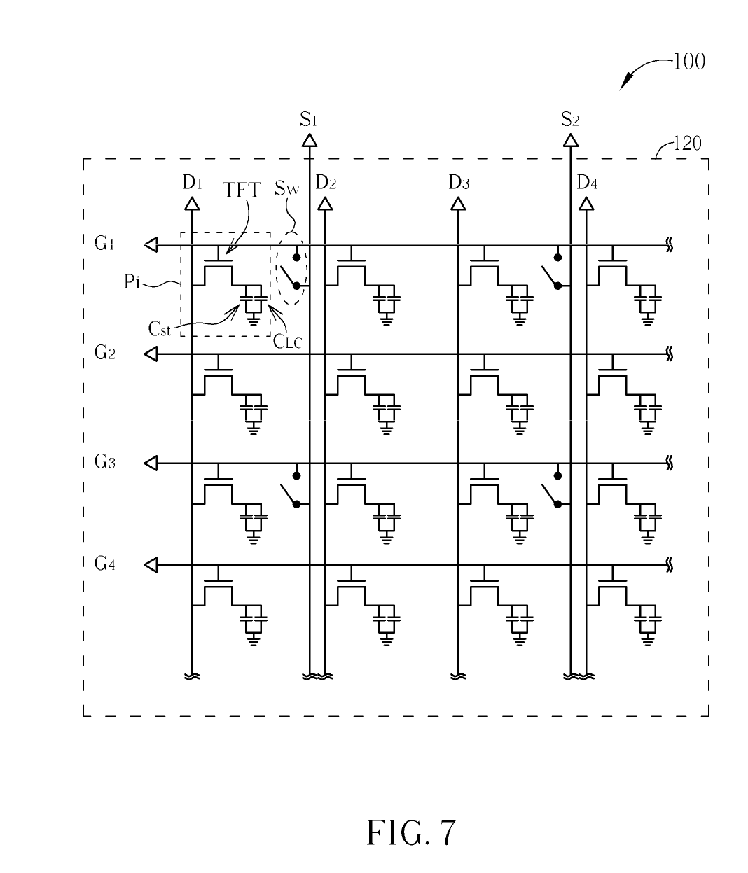

FIG. 7 is a schematic diagram of an equivalent circuit of the touch panel 100 of the first embodiment of the present invention. As illustrated in FIG. 7, the touch panel 100 includes a pixel array 120 and a plurality of sensing lines S1 and S2. The pixel array 120 includes a plurality of scan lines G1, G2, G3 and G4, a plurality of data lines D1, D2, D3 and D4, a plurality of display regions Pi, and a plurality of sensing structures Sw. The display region Pi includes a thin film transistor TFT, a liquid crystal capacitor C_{LC}, and a storage capacitor Cst, wherein a drain electrode of the thin film transistor TFT is electrically connected to a pixel electrode. The sensing structure Sw acts as a switch unit through the previous discussed connection terminals 106a and 106b and the conductive protrusions 152. A primary function of the sensing structure Sw is to deliver scan signals to the sensing lines S1 and S2 through the scan lines G1 and G3 directly. According to FIG. 3 and FIG. 7, the sensing structure Sw of the present invention may be disposed at some of the pixel, while the rest of the pixels do not have the sensing structure Sw disposed.

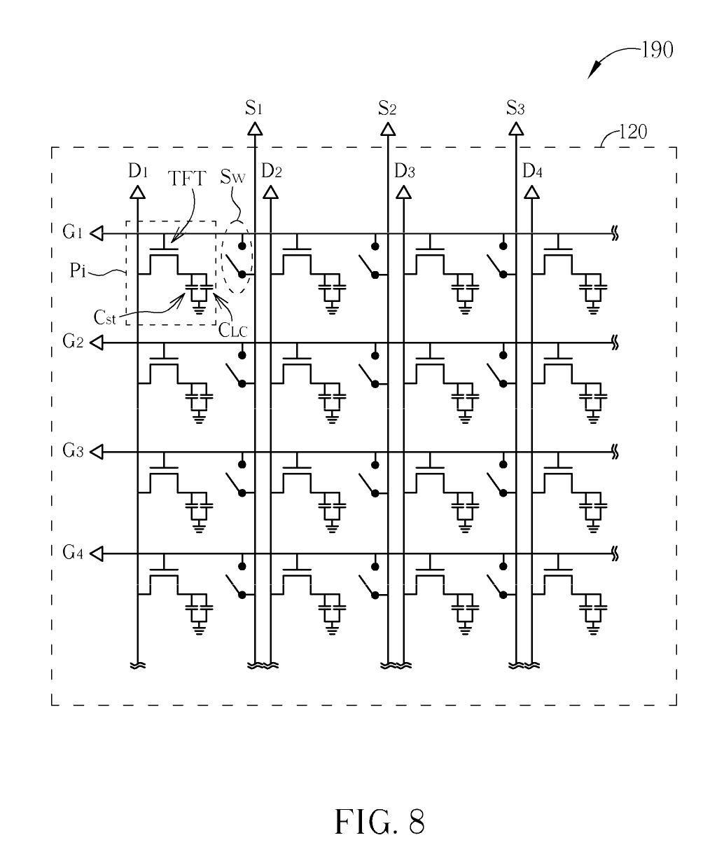

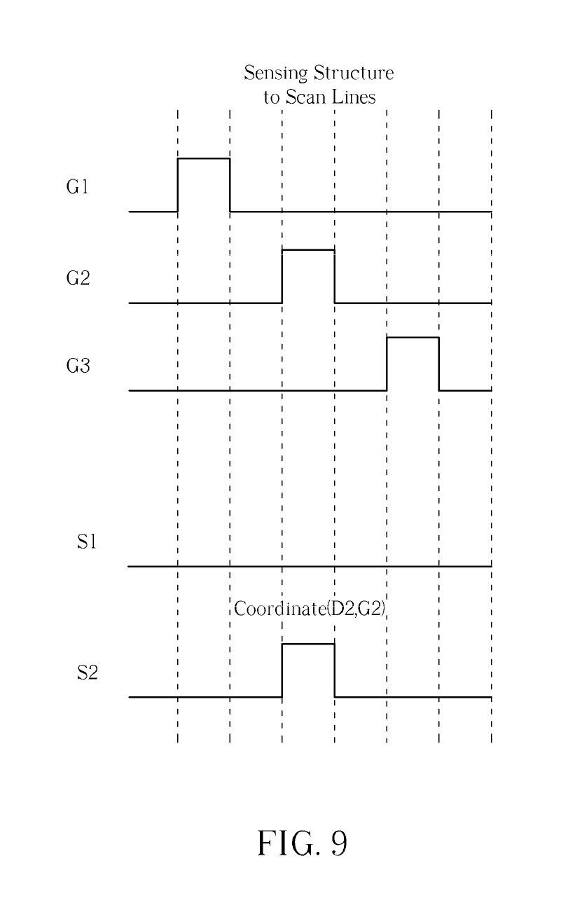

FIG. 8 is a schematic diagram of an equivalent circuit of a touch panel 190 of a second embodiment of the present invention, and FIG. 9 illustrates the driving sequence with corresponding sensing signals of the touch panel 190 of the second embodiment. As illustrated in FIG. 8, a main difference between the first embodiment and the second embodiment is the second embodiment has a sensing structure Sw in every pixel, and the touch panel 100 includes a plurality of sensing lines 51, S2, and S3. As illustrated in FIG. 9, during scanning, the display device provides scan signals to scan lines G1, G2, G3 and G4. When an external force is applied to a corresponding sensing structure Sw of the sensing line S2 and scan line G2, the conductive protrusion 152 of the pressed sensing structure Sw contacts the connection terminal of the scan line G2 and the connection terminal of the sensing line S2 simultaneously; therefore, the scan signals of the scan line G2 are directed to the sensing line S2 through the sensing structure Sw and become sensing signals. Then, the sensing line S2 transfers the sensing signals, such as to an amplifier. Next, a determining circuit determines corresponding locations of the sensing signals. In the present embodiment, the determining circuit is informed that the sensing signals are delivered from the sensing line S2; it then analyzes the sensing signals and determines the relative position of the external applied force through correlating the instant when the sensing line S2 is at a high voltage level which in this case reveals the scan line G2 as the corresponding scan line. Therefore, the determining circuit determines the corresponding sensing structure Sw of the position of the applied external force through determining the corresponding scan line G2 and sensing line S2.

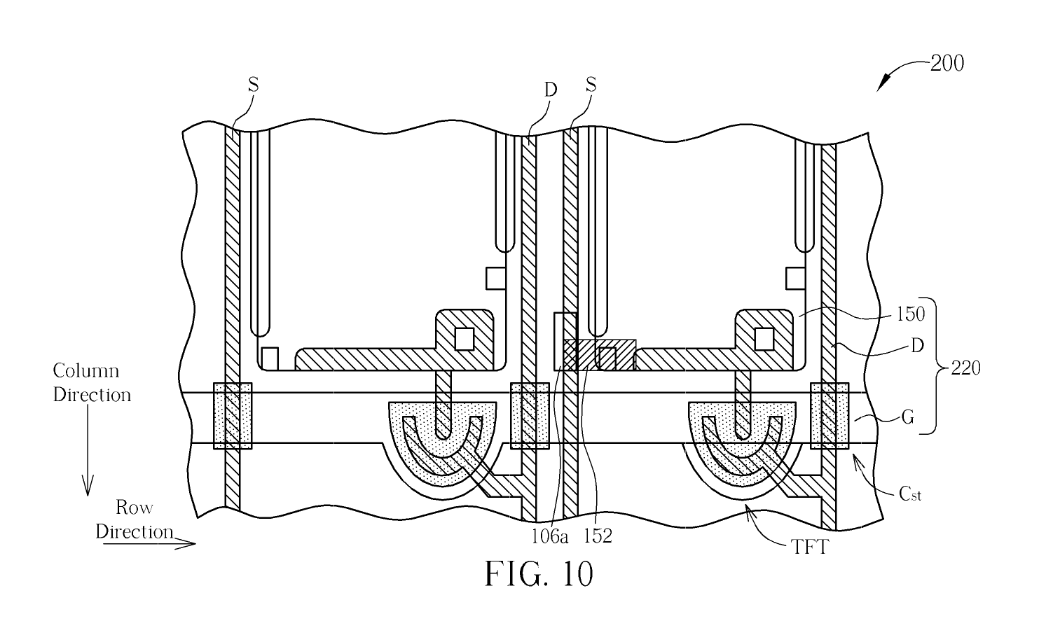

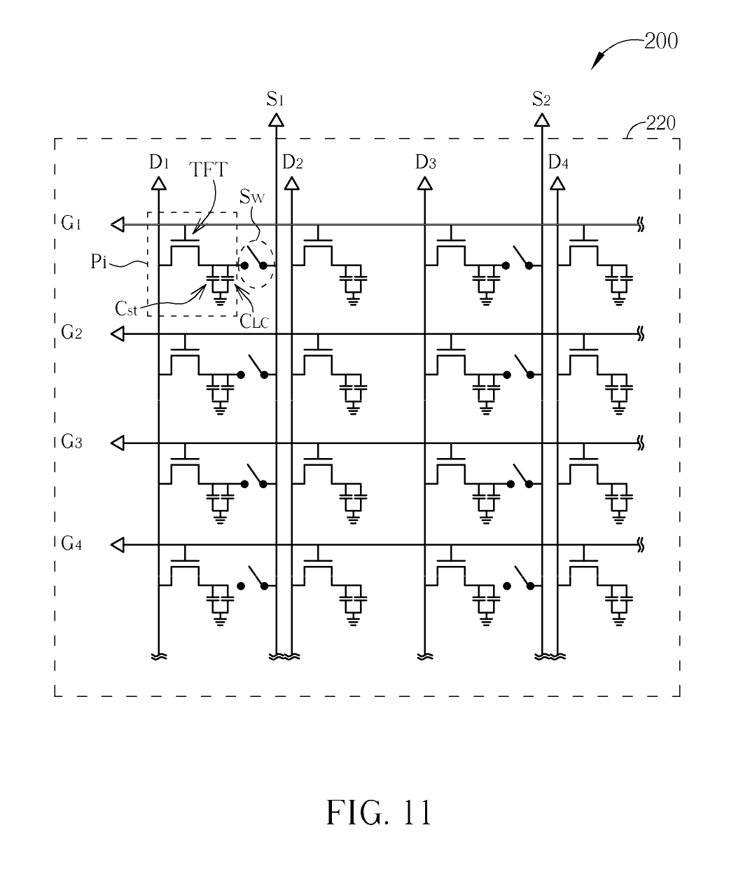

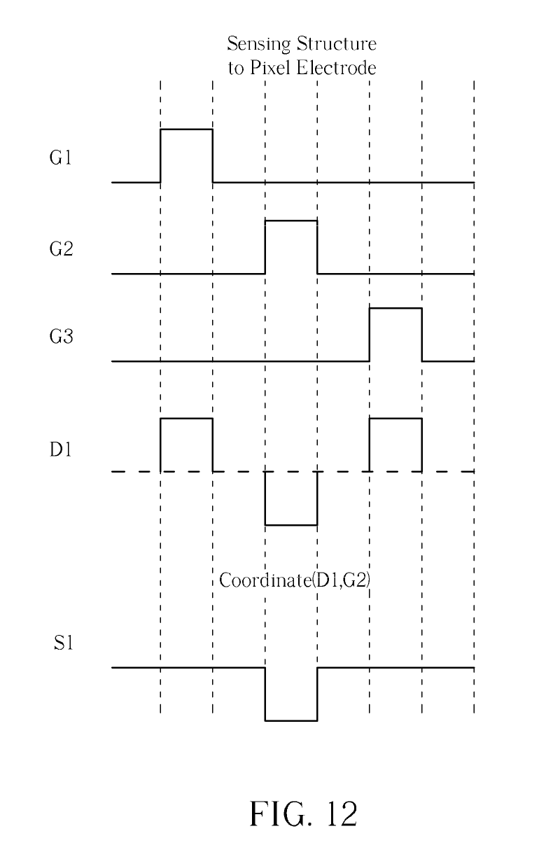

FIG. 10 to FIG. 12 illustrate a touch panel 200 of the third embodiment of the present invention. FIG. 10 is a schematic perspective layout diagram of the touch panel 200, FIG. 11 is a schematic diagram of an equivalent circuit of the touch panel 200, and FIG. 12 is a schematic diagram illustrating the driving sequence with corresponding sensing signals of the touch panel 200. To simplify the description and for the convenience of comparison between each of the embodiments of the present invention, identical elements are denoted by identical numerals. Also, only the differences are illustrated, and repeated descriptions are not redundantly given. As illustrated in FIG. 10, a main difference between the first embodiment and the third embodiment is that the conductive protrusion 152 of the third embodiment is corresponding to the sensing line S and the pixel electrode 150, i.e. the conductive protrusion 152 is located above the sensing line S and the pixel electrode 150. When the conductive protrusion 152 is pressed, an external force pushes the conductive protrusion 152 downwards and thus the conductive protrusion 152 contacts both one of the sensing lines S and one of the pixel electrodes 150 simultaneously. Therefore, the conductive layer 108a of the conductive protrusion 152 is electrically connected to the corresponding sensing line S and the pixel electrode 150, and transfers the sensing signals through the connected sensing lines S.

As illustrated in FIG. 11, the touch panel 200 includes a pixel array 220, and a plurality of sensing lines S1 and S2. The pixel array 220 includes a plurality of scan lines G1, G2, G3 and G4, a plurality of data lines D1, D2, D3 and D4, a plurality of display regions Pi, and a plurality of sensing structures Sw. The sensing structures Sw includes the previous described conductive protrusion 152, the connection terminals of the sensing lines S1 and S2, and the connection terminal of the pixel electrode 150. The primary function of the sensing structure Sw is to transfer data line signals (image signals) to the sensing lines S1 and S2 through the data lines D1, D2, D3 and D4, and the thin film transistor TFT.

As illustrated in FIG. 12, during scanning, the display device provides the scan signals to the scan lines G1, G2, G3 and G4, and also provides a plurality of sensing data signals to the data lines D1, D2, D3 and D4. When a sensing structure Sw corresponding to the data line D1 and the scan line G2 is pressed by an external force, the conductive protrusion 152 of the pressed sensing structure Sw contacts the sensing line S1 and the pixel electrode 150 connected to the data line D1 simultaneously. The scan signals of scan line G2 turns on a corresponding thin film transistor TFT and transfers the data line signals of the data line D1 to the sensing line S1 through a turned on sensing structure Sw; the data line signals then become the sensing signals. Next, the sensing line S1 transfers the sensing signals to an amplifier and then the determining circuit analyzes the sensing signals and observers changes of voltage level of corresponding pixel electrodes 150 to determine the corresponding location of the external applied force. In the present embodiment, the determining circuit is informed that the sensing signals are delivered from the sensing line S1; it then analyzes the sensing signals and determines the relative position of the external applied force through analyzing the change of voltage level of the corresponding pixel electrode 150 of the sensing signal which reveals the scan line G2 as the corresponding scan line. Thus the determining circuit determines the corresponding sensing structure Sw of the position of the applied external force through determining the corresponding data line D1 and scan line G2.

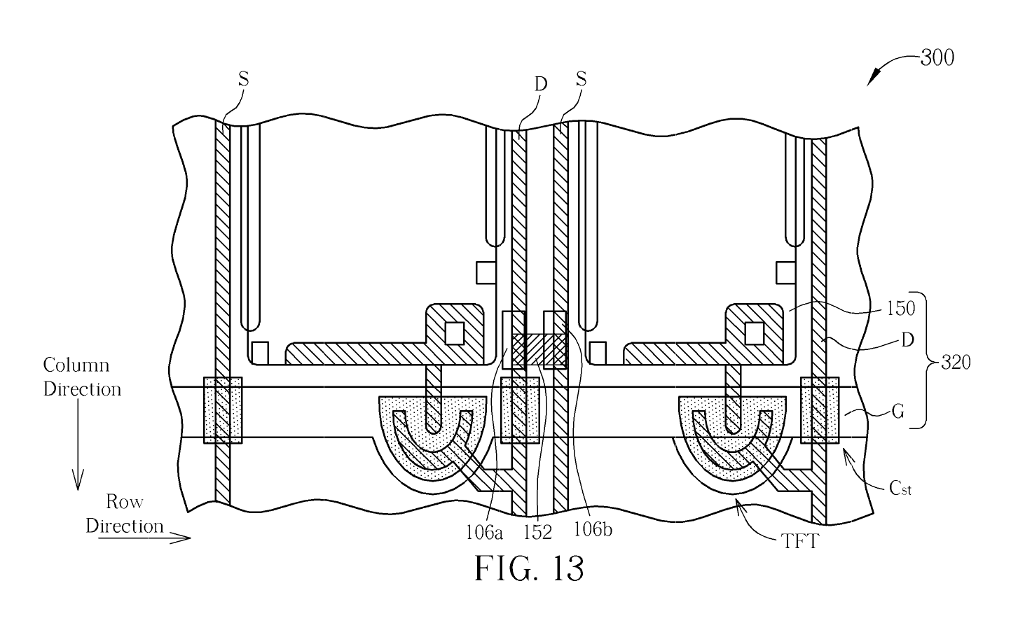

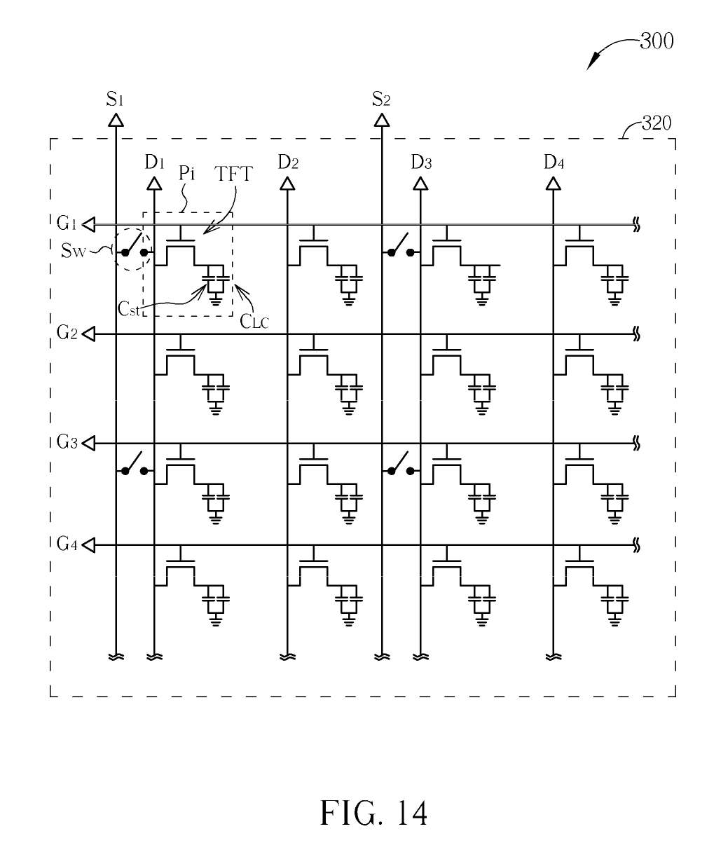

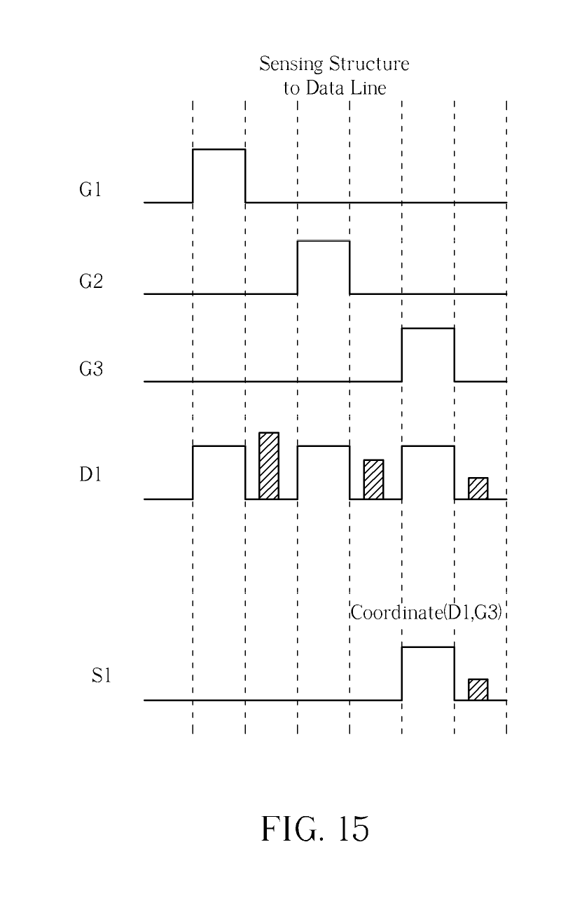

FIG. 13 to FIG. 15 are schematic diagrams of a touch panel 300 of a fourth embodiment of the present invention. FIG. 13 is a perspective layout diagram of the touch panel 300, FIG. 14 is an equivalent circuit diagram of the touch panel 300, and FIG. 15 is a schematic diagram illustrating the driving sequence of the corresponding sensing signals of touch panel 300. As illustrated in FIG. 13, a main difference between the first embodiment and the fourth embodiment is that the conductive protrusion 152 of the fourth embodiment is corresponding to the sensing line S and the data line D, i.e. the conductive protrusion 152 is located above the sensing line S and the data line D. When the conductive protrusion 152 is pressed, an external force pushes the conductive protrusion 152 downwards and the conductive protrusion 152 contacts both one of the sensing lines S and one of the data line D simultaneously. Therefore, the conductive layer 108a of the conductive protrusion 152 is electrically connected to the corresponding sensing line S and the data line D, and transfers the sensing signals through the connected sensing line S.

As illustrated in FIG. 14, the touch panel 300 includes a pixel array 320, and a plurality of sensing lines S1 and S2. The pixel array 320 includes a plurality of scan lines G1, G2, G3 and G4, a plurality of data lines D1, D2, D3 and D4, a plurality of display regions Pi, and a plurality of sensing structures Sw. The sensing structures Sw includes the previous described conductive protrusion 152, the connection terminals of the sensing lines S1 and S2, and the connection terminals of the data lines D1 and D3. The primary function of the sensing structure Sw is to deliver sensing data signals to the sensing lines S1 and S2 through the data lines D1 and D3.

As illustrated in FIG. 15, during scanning, the display device provides the scan signals to the scan lines G1, G2, G3 and G4, and provides a plurality of sensing data signals to the data lines D1, D2, D3 and D4. During intervals of providing scan signals to the scan line G1, G2, G3 and G4, a plurality of sensing data signals are provided to the data lines D1 and D3 respectively. When corresponding sensing structure Sw of the data line D1 and the scan line G3 is pressed by an external force, the conductive protrusion 152 of the pressed sensing structure Sw contacts both the sensing line S1 and the data line D1 simultaneously. The scan signals of scan line G3 turn on a corresponding thin film transistor TFT which transfers the data line signals of the data line D1 and the following sensing data signals to the sensing line S1 through the turned on sensing structure Sw, becoming sensing signals. Next, the sensing line S1 transfers the sensing signals to an amplifier and then the determining circuit analyzes the sensing signals of the corresponding data line D1 to determine the corresponding location of the external applied force. In the present embodiment, the determining circuit is informed that the sensing signals are delivered from the sensing line S1; it then analyzes the sensing signals and determines the data line D1 corresponding to the sensing signals and the corresponding scan line G3. Therefore, the determining circuit determines the corresponding sensing structure Sw of the position of the applied external force through determining the corresponding data line D1 and scan line G3.

In summary, the present invention has advantages as follows: First of all, the present invention utilizes the conductive protrusion of the top substrate as a bridge structure; when pressed, the conductive protrusion of the top substrate contacts the sensing line and the pixel array below which transfers the signals of the pixel to the sensing lines. Therefore, the sensor readout transistors are not required at the pixel arrays which effectively increases the aperture ratio of the pixel array. In other words, the present invention does not utilize the common voltage of the common electrodes as the sensing signals. Under no externally applied force, the conductive protrusions are floating without a voltage; when the touch panel is pressed, the conductive protrusion becomes a path for electrical connection. Also, the common electrode on the top substrate of the present invention does not cover the surface of the spacer photoresist layer completely, and the common electrode is electrically insulated from the conductive protrusion, which shortens a distance between the pixel electrode and the spacer photoresist layer and further increased the aperture ratio.

Those skilled in the art will readily observe that numerous modifications and alterations of the device and method may be made while retaining the teachings of the invention.

What is claimed is:

1. A touch panel comprising:
a first substrate, comprising a pixel array and a plurality of sensing lines;
the pixel array comprising:
a plurality of scan lines, extended in a row direction;
a plurality of data lines, extended in a column direction; and
a plurality of pixel electrodes, disposed between the scan lines and the data lines and connected to corresponding scan lines and data lines;
the sensing lines, parallel in the pixel array, disposed near the pixel electrodes, and electrically insulated from the scan lines, the data lines and the pixel electrodes;
a second substrate, comprising a plurality of conductive protrusions, corresponded with the disposed sensing lines; and
a liquid crystal layer, disposed between the first substrate and the second substrate;
wherein when an external force is applied, at least one of the conductive protrusions contacts one of the scan lines and part of the pixel array, and transfers a sensing signal through one of the sensing lines.

2. The touch panel display of claim 1, wherein the second substrate further comprises a plurality of pixel units aligning with the corresponding pixel electrodes, and the conductive protrusions are electrically insulated from the pixel units.

3. The touch panel display of claim 2, wherein the conductive protrusion further comprises a conductive layer and at least a photoresist layer, an organic layer, or a black matrix, wherein the conductive layer is disposed at parts of surfaces of the photoresist layer, the organic layer, or the black matrix.

4. The touch panel display of claim 1, wherein the sensing lines are extended in a column direction and aligned in parallel to each other in the pixel array; when an external force is applied, at least one of the conductive protrusions contacts one of the sensing lines and one of the scan lines simultaneously, and transfers the sensing signal through one of the sensing lines.

5. The touch panel display of claim 1, wherein the sensing lines are extended in a column direction and aligned in parallel to each other in the pixel array; when an external force is applied, at least one of the conductive protrusions contacts one of the sensing lines and one of the pixel electrodes simultaneously, and transfers the sensing signal through one of the sensing lines.

6. The touch panel display of claim 1, wherein the sensing lines are extended in a column direction and aligned in parallel to each other in the pixel array; when an external force is applied, at least one of the conductive protrusions contacts one of the sensing lines and one of the data lines simultaneously, and transfers the sensing signal through one of the sensing lines.

7. A sensing method for a touch panel, the touch panel comprising:
a first substrate, comprising a pixel array and a plurality of sensing lines;
the pixel array comprising:
a plurality of scan lines, extended in a row direction;
a plurality of data lines, extended in a column direction; and
a plurality of pixel electrodes, disposed between the scan lines and the data lines and connected to corresponding scan lines and data lines;
the sensing lines, parallel to the pixel array, disposed near the pixel electrodes, and electrically insulated from the scan lines, the data lines, and the pixel electrodes;
a second substrate, comprising a plurality of conductive protrusions, corresponded with the disposed sensing lines; and
a liquid crystal layer, disposed between the first substrate and the second substrate;
the sensing method comprising:
supplying a scan signal to the scan lines;
applying an external force to the touch panel causing at least one of the conductive protrusions to contact with one of the sensing lines and parts of the pixel array simultaneously;
using one of the sensing lines to transfer a sensing signal; and
determining a corresponding position of the sensing signal.

8. The sensing method of the touch panel of claim 7, further comprising: causing at least one of the conductive protrusions to contact with one of the sensing lines and one of the scan lines simultaneously.

9. The sensing method of the touch panel of claim 8, further comprising analyzing an instant of a high voltage level of the corresponding sensing signals to determine a corresponding position of an external applied force.

10. The sensing method of the touch panel of claim 7, further comprising:
causing the at least one of the conductive protrusions to contact with one of the sensing lines and one of the pixel electrodes simultaneously.

11. The sensing method of the touch panel of claim 10, further comprising analyzing a change in voltage level of the sensing signals of the corresponding pixel electrodes to determine a corresponding position of an external applied force.

12. The sensing method of the touch panel of claim 7, further comprising:
providing a plurality of sensing data signals to the data lines respectively at each interval of providing scan signals to the scan lines.

13. The sensing method of the touch panel of claim 12, further comprising:
causing at least one of the conductive protrusions to contact with one of the sensing lines and one of the data lines simultaneously.

14. The sensing method of the touch panel of claim 13, further comprising analyzing the sensing signals corresponding to the sensing data signals of one of the data lines to determine a corresponding position of an external applied force.
